(19) United States
(12) Patent Application Publication
(10) Pub. No.: US 2010/0191353 A1
(43) Pub. Date: Jul. 29, 2010

(54) APPARATUS AND METHOD FOR MODIFYING A LIGHT SCENE

(75) Inventors: Salvador Expedito Boleko Ribas, Barcelona (ES); Felix Henric Govert Ogg, Eindhoven (NL); Matthias Wendt, Wurselen (DE); Dirk Valentinus Rene Engelen, Heusden-Zolder (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/667,245

(22) PCT Filed: Jul. 2, 2008
(86) PCT No.: PCT/IB08/52659

§ 371 Date: Dec. 30, 2009

(30) Foreign Application Priority Data
Jul. 5, 2007 (EP) 07111817.8

(51) Int. Cl. G06F 17/00

(52) U.S. Cl. 700/90

(57) ABSTRACT

The invention relates in general to an apparatus and a method for modifying a light scene. According to an embodiment of the invention, an apparatus (204) for modifying a light scene composed from an abstract description is provided, wherein the apparatus comprises means (252) for selecting an area of the light scene, means (254) for modifying a light condition of the area, means (256) for recording at least one parameter referring to a modification of the light condition of the area and means (258) for adapting the abstract description based on the at least one parameter.

The invention relates in general to an apparatus and a method for modifying a light scene.

Lighting is increasingly used for decoration purposes. Lighting systems for decoration purposes can already be found in shops, hotel lobbies, hotel rooms, restaurants etc. These lighting systems consist of a relatively large number of light units or lighting devices, for example hundreds or even thousands of LEDs (Light Emitting Diodes) or light sources of different technologies such as fluorescent, incandescent light sources, that together are used to create a certain lighting atmosphere in the room that they are applied to.

Developments in lighting modules and lighting controls enable the creation of complex lighting atmospheres or scenes. To that purpose a plurality of light sources and hence control degrees of freedom are needed. Consequently, flexible handling of such complex infrastructures should demand for the development of an automatic lighting system. The automatic lighting system may provide tools which at least partly automate a lighting atmosphere creation and rendering process.

In a light management system an abstract (atmosphere) description language (ADL) may be used for a specification of light atmospheres.

It is an object of the present invention to provide an improved apparatus and an improved method for modifying a light scene.

The object is solved by the independent claims. Further embodiments are shown by the dependent claims.

The inventive approach may be integrated as a component of an advanced automated lighting control and management system. The abstract (atmosphere) description language (ADL) may be used. The abstract (atmosphere) description language allows a description of a light scene without any explicit knowledge about particularly installed lighting hardware or a specific layout of a room among others. The invention allows a script editor to use a reference location or reference shop for a creation and fine-tuning of a light script. It offers an end-user of the lighting system to adapt the light script to the users taste and save modifications for future re-use.

Thus, a basic idea of the invention is a generalisation of light scenes through feedback of locally fine-tuned lighting effects.

More specific, the inventive approach is on how to back track modifications done interactively in a final room towards the abstract description language which defines a light scene. This may be necessary in order to make the modifications directly in a specification source, like an abstract description language script, rather than only on a final light rendering for the tweaked situation.

In this way the modifications may be remembered even when a light installation changes, the abstract description language script is rendered in another room or other reasons lead for a new calculation of all control parameters of the light scene.

As such the inventive method closes a gap between automatically calculated lighting atmospheres and manually adjusted light scenes. Such functionality may be required by customers of a light system.

According to an embodiment of the invention, an apparatus for modifying a light scene composed from an abstract description is provided, comprising:
means for selecting an area of the light scene;
means for modifying a light condition of the area;
means for recording at least one parameter referring to a modification of the light condition of the area; and
means for adapting the abstract description based on the at least one parameter.

The term “light scene” or “light atmosphere” means a combination of different lighting effects such as intensities of different spectral components, colours or spectral components.

The abstract description allows defining the intended light scene independent from a concrete instance of a lighting system or a room. In other words, the abstract description is room and lighting infrastructure independent, thus enabling to use only one description of a certain lighting atmosphere that may then be transferred to many different specific instances of lighting systems or rooms.

The abstract description may comprise an abstract (atmosphere) description language script. The abstract (atmosphere) description language may be advantageously be used as it integrates some primitives that allow for describing light effects in terms of colour, correlated colour temperature, illuminance, etcetera.

According to an embodiment, the means for selecting may comprise a pointing tool allowing a user to select the area. An advantage of the pointing tool is, that it is a device, which can easily be handled by untrained persons.

According to a further embodiment, the means for modifying may comprise a user interface allowing a user to input a modification command and the means for modifying may be configured to modify the light condition of the area based on the modification command. This allows the user to directly input any desired modifications.

The means for modifying may be configured to interact with a control system which controls the light scene in order to modify the light condition of the area. This allows performing the modification without changing the abstract description.

Alternatively, the means for modifying may be configured to change the abstract description in order to modify the light condition of the area. This may allow performing the modification independently from an underlying light system or infrastructure.

According to a further embodiment, the means for modifying may comprise a movable light-emitting device allowing a user to modify the light condition of the area. This allows a user to modify the light scene without having to input a modification command. Even untrained users may use the light-emitting device to modify the light scene. Further, the user may use any light-emitting device that is suitable to modify the light condition of the area as desired. Thus, the user may try light-emitting devices that are not provided by the apparatus for modifying a light scene.

The means for recording may comprises at least one detector for measuring the at least one parameter. A detector is a reliable instrument to record any modifications of the light scene. Further, due to the detector, there is no need for the user to provide the at least one parameter.

The means for adapting may be configured to adapt the abstract description by deducing at least one value of the abstract description. This allows creating a modified abstract description, which may be used to compose the modified light scene in the future.

Further, the means for adapting may be configured to display the at least one value to the user. This allows the user to observe any changes of the abstract description.

According to a further embodiment, the means for adapting may be configured to adapt the abstract description by determining a filter that defines an interpretation of the abstract description. Thus, there is no need to change the abstract description itself.

The filter may comprise a look-up-table for storing interpretation values that are assigned to values of the abstract description. A look-up-table is easy to implement.

According to a further embodiment of the invention, a lighting system is provided, comprising:
means for composing a light scene from an abstract description; and
an apparatus according to the invention.

The term “lighting system” may comprise a complex system for illumination that may contain several lighting units.

According to a further embodiment of the invention, a method for modifying a light scene composed from an abstract description is provided, comprising the steps of:
selecting an area of the light scene;
modifying a light condition of the area;
recording at least one parameter referring to a modification of the light condition of the area; and
adapting the abstract description based on the at least one parameter.

The method for modifying a light scene may be used for a lighting system or an apparatus for modifying a light scene according to embodiments of the invention.

According to a further embodiment of the invention, a computer program may be provided, which is enabled to carry out the above method according to the invention when executed by a computer. This allows realizing the inventive approach in a compiler program.

According to a further embodiment of the invention, a record carrier storing a computer program according to the invention may be provided, for example a CD-ROM, a DVD, a memory card, a diskette, or a similar data carrier suitable to store the computer program for electronic access.

These and other aspects of the invention will be apparent from and elucidated with reference to the embodiments described hereinafter.

The invention will be described in more detail hereinafter with reference to exemplary embodiments. However, the invention is not limited to these exemplary embodiments.

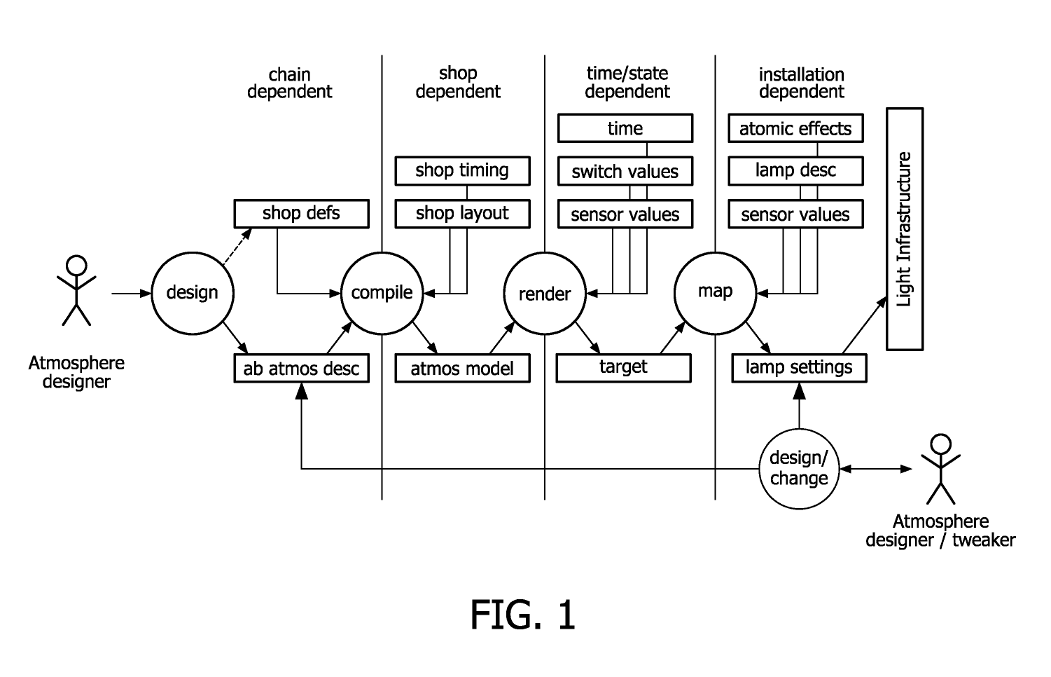

FIG. 1 shows an automatic lighting system according to the invention;

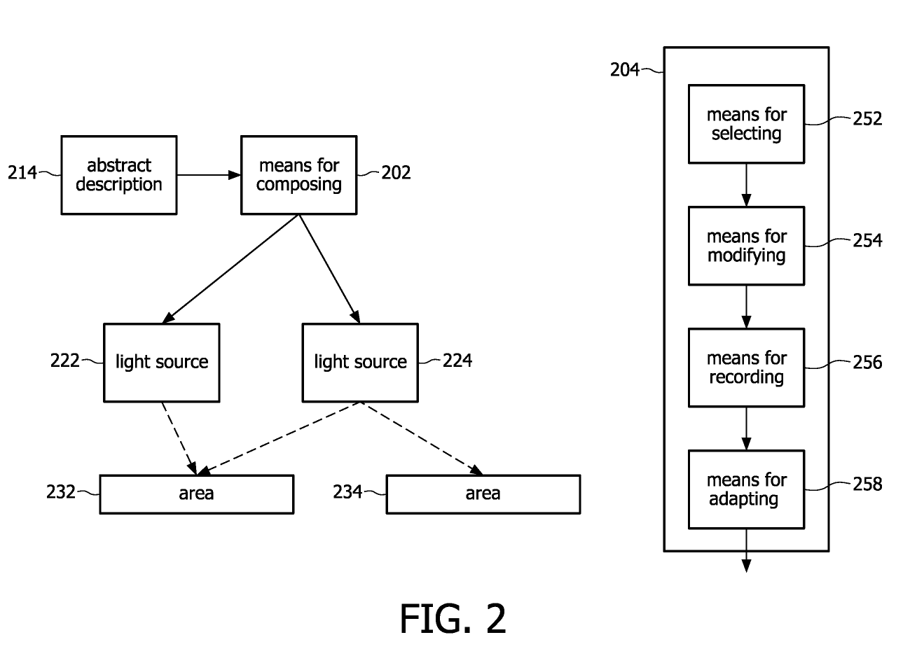

FIG. 2 shows a further lighting system according to the invention; and

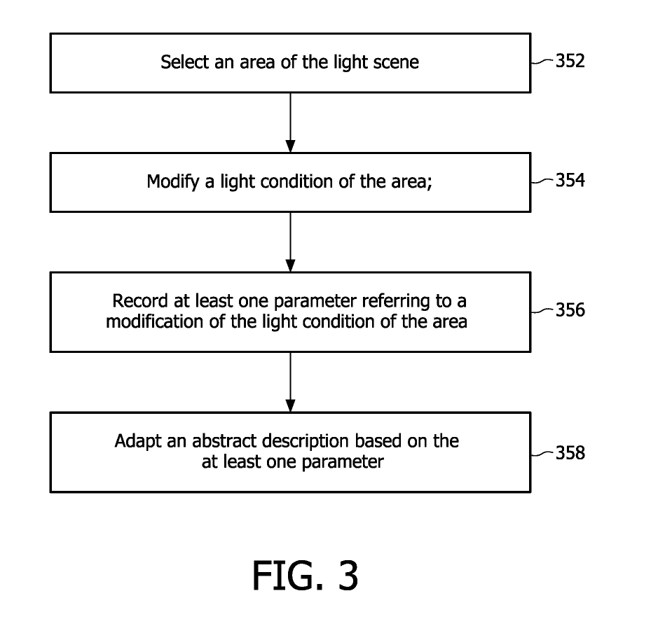

FIG. 3 shows a flow diagram of a method for modifying a light scene according to the invention.

In the following, functionally similar or identical elements may have the same reference numerals.

FIG. 1 shows an embodiment of a lighting system or lighting management system according to an embodiment of the invention. A so-called rendering pipeline enables automated translation of one specification of a light scene into a light scene rendered in accordance with the available light modules. In particular FIG. 1 depicts an overview of a flow of a method for composing a lighting atmosphere from an abstract description for a shop.

Via a design process, for example by using a lighting atmosphere composition computer program, an abstract atmosphere description “ab atmos desc” is created. The abstract description may merely contain descriptions of lighting effects at certain semantic locations at certain semantic times or occasions. The lighting effects may be described by the type of light with certain parameters. The abstract description may be shop layout and lighting system independent. Thus, it may be created by a lighting designer without knowledge about a specific lighting system and lighting environment such as a room layout. The designer must know only semantic locations of the lighting environment.

The abstract atmosphere description may also be generated or adapted by interaction of an atmosphere designer or tweaker via a procedure “design/change” as depicted at the bottom of FIG. 1.

The abstract description may be automatically translated into control values for the different lighting devices or units in three stages.

In a compilation stage, the abstract description is translated into a shop dependent atmosphere model. This implies that shop dependent parameters like shop timing, e.g. opening hours or shop layout are available at the compile stage.

In a rendering stage, all dynamics, time dependencies and sensor dependencies are removed from the atmosphere model. As such, the render stage creates a snapshot of the light atmosphere at a certain point in time and given sensor readings at that point in time. The output of the render stage is called target. The target can consist of one or more viewpoints and per viewpoint a colour distribution, an intensity distribution or a Colour Rendering Index distribution.

A mapping stage converts the target into actual lamp settings. In order to calculate the lamp settings, the mapping loops require installation dependent parameters like atomic effects, lamp descriptions or sensor values. The lamp settings are used to control a light infrastructure in order to achieve the intended light atmosphere.

The lamp settings may also be generated or adapted by interaction of the atmosphere designer or tweaker via the procedure “design/change” as depicted at the bottom of FIG. 1.

For the rendering pipeline as shown in FIG. 1, the abstract (atmosphere) description language (ADL) may be used in order to write a specification for the intended light scene. One of the roles of ADL is to allow the description of a light scene without any explicit knowledge about the particularly installed lighting hardware or the specific layout of the room among others. This ability provides high flexibility and portability to design light scenes.

A clear example where the capabilities of such an automated system can be shown is that of a chain of shops, which as part of its brand image policy, adopts a common lighting design for all of its establishments. As illustrated in FIG. 1 for the case of a particular shop, the initial specification together with additional information collected at different stages of a process yields as a result the at least partly automated rendering of a light scene that approximates the one intended.

It may be the case that an end-user is not satisfied with the automatically rendered solution and thus desires to introduce improvements or modifications to it. The end-user may use a pertinent tool or interface, e.g. a LightWand that allows the user to modify the settings initially computed by the light management system (LMS). Once the end-user is satisfied with the resulting modified light scene, the user may proceed to store the modified settings.

Such process is convenient if the light scene is to be rendered just at that specific room, where the tweaking of the original one took place, with the lighting equipment therein installed. However, this is may be not the case anymore if either the modified scene is to be rendered at a different location or the lighting equipment differs from the one used during the modification.

The present invention intends to fine-tune light colour, as well as other similar effects, in a space controlled by an automatic lighting system comprising a rendering pipeline as shown in FIG. 1.

One of the benefits of adopting ADL in the context of an automatic lighting system is flexibility and portability of light designs. However, writing ADL scripts may be a difficult or tedious task to non-trained end users, as well as conflicting with the target of developing an automated lighting system.

Furthermore, possibly a priori envisioning of a look of the actually rendered light atmosphere from its ADL script prior to execution may not even be possible at all as, on the one hand it depends on the available infrastructure, lighting equipment, and layout and on the other hand ADL is meant to allow the atmosphere creator to neglect local circumstances, which may impact the final rendering of the light scene.

If the light scene achieved through fine-tuning or modification of another light scene is to be rendered at any other location, like a room perhaps featuring different layout and lighting modules, then it is required to translate the resulting ambiences back into ADL.

The tweaking step allows for the local adaptation to, at design stage, unforeseen local conditions, as well as visualising the result of the modifications.

This portability allows for instance lighting designers to run their own ADL scripts in a reference shop and then to fine-tune the designed atmosphere until it reaches the expected or required quality.

In case of a digitally controlled lighting system, after tweaking, the resulting new control values can be stored. In case of a control panel with sliders, a photo can be used to preserve the control values of the tweaked state. Both solutions are rather awkward and none of them allows the generalisation, i.e. portability of the improvements of the original script.

The present invention describes solutions to realise that reverse translation into ADL of an ambience obtained through modifying or fine-tuning an automatically rendered light scene.

According to an embodiment a tweaking tool is provided that enables a modification of settings, particularly the lighting settings associated to an automatically rendered original light scene.

Optionally, a user interface may be provided that supplies tools that indicate, according to the original script, the location and, if needed, properties of the surface or surfaces whereon the light effects are to be realised. This may be a software tool, or it may be a device that indicates a geographical location, that can be tracked back to a location in the light script.

Further, photometric detectors may optionally be provided that make readings of the resulting light magnitudes. Such measurements allow a consistent recording of modifications to the original light design in terms of colour, colour temperature or illuminance to be quantified, so that they can be used to generate a new ADL script. In accordance with its function, ADL may integrate some primitives or instructions that allow for describing light effects in terms of colour, correlated colour temperature or illuminance. Sensors can be omitted whenever the result of the modification cannot be easily measured or other methods exist so that the modification can be more easily characterised. For instance if a database exists which makes available a direct relationship between a modification in terms of specification, like an ADL script, and a rendered effect. As an example, an original script light scene is considered which integrates an effect that results from using a gobo pattern A. After tweaking the gobo pattern A may be changed to B. For such a case it is much simpler for a user to directly report the change of the applied gobo pattern through the user interface, than abstracting the change into a modified script through measurements.

Further, software tools are provided which modify the original script, in accordance with the introduced changes.

A further embodiment of the invention describes a method for changing of an input script and storage of a modified specification.

As a starting point, an existing ADL script is actuated on a room's lighting. Illuminated surfaces in the room are associated to a representation of the surface or area in the lighting system's spatial model.

An end-user may take a pointing tool, e.g. an uWand or a computer mouse and points to a physical or visualized area to be modified. By issuing a command, the user may modify the light conditions instantaneously at the surface the user has selected by the pointing tool. The modification command may be applied to the associated representation of the physical area in the spatial model.

A modification of the parameters of one area may result in the modification of other areas, for example, if they are part of the same aggregate of areas. This may be visualised on a screen to prevent irritating the user.

Issuing the command may be realized by using control sliders or any other tool, e.g. an uWand, allowing the user to interact with a control system of the lighting system. Further, a device that emits light by itself, like a torchlight, may be used to shift the rendered effect in the desired direction. For example, the device that emits light by itself may be used for increasing brightness or changing the hue, saturation or colour temperature. Further, other control modalities that allow for directly changing script values and then re-rendering of the modified script, to actualise the changes made until the desired effect has been reached may be used.

The methods of issuing the command by using control sliders or any other tool and shifting the rendered effect by using the device that emits light by itself require the resulting light effect to be measured by photometric detectors to deduce their counterpart ADL values, preferably automatically. Deduced values, or simplified representations thereof, may be displayed on a screen to the end-user to let him agree with the machine observations.

The back tracking system may as well use photometric measurements to learn about the new setting for the tweaked atmospheres. As it also can make use of interpolation techniques by using darkroom calibration information to calculate the effect that needs to be described in ADL to exactly lead to the rendered atmospheres that has been initially modified by hand.

For the darkroom calibration the light units are driven one by one. Cameras and/or sensors measure the effect of each single light unit on the environment. Each camera or sensor corresponds to one viewpoint. By measuring the yielded effect in this way, influences of wall colours, furniture, carpet etc. are taken into account automatically. Besides measuring the effect of each light unit, it should be indicated which physical locations are measured for every camera and sensor. As far as cameras are concerned, the camera view itself can be used to indicate the physical locations of the shop.

Finally, the modified ADL script may be stored.

A further embodiment of the invention describes a method for change rendering of input scripts for a specific instance of the automatic lighting system or room.

In accordance with the previous embodiment a user may select an area of the light scene to be modified.

Instead of a modified ADL script as it is the outcome of the previous embodiment, the outcome of the fine-tuning according to this embodiment is changed in the way specific instructions or commands in the ADL script are interpreted. To that purpose, and due to the local scope of this generalisation process, changes are now stored in a system-instance-specific, i.e. non-general space description filter, which can be implemented as a look-up table that is used for all future renderings of any atmosphere description script, forming a “from-now-on function”.

For example, whenever the system targets to render a pale shade of blue on a certain wall the user is pointing at, from now on, the system should instead render a saturated, more vivid, bluish effect there, e.g. to compensate for the paint of that wall. This change only affects this wall, for example at a specific street address, shop instance Or room.

This approach can be learned by shop personnel and shop decorators within 5 minutes, for example, without any training. An atmosphere design is used as a starting point to fine-tune the light atmosphere to their liking, and as frequently as needed.

FIG. 2 depicts a lighting system comprising means 202 for composing a light scene from an abstract description and an apparatus 204 for modifying a light scene composed from an abstract description, according to an embodiment of the invention.

The means 202 for composing is configured to compose a light scene from the abstract description that may be provided from a memory 214. The abstract description may be an abstract description language script. The means 202 for composing may comprise a rendering pipeline as depicted in FIG. 1. The means 202 for composing is configured to calculate control parameters for controlling light sources 222, 224 from the abstract description. The light sources 222, 224 are used to create the desired light scene. The light scene comprises areas 232, 234 to be illuminated by the light sources 222, 224. The lighting system may comprise further light sources and the light scene may comprise further areas to be illuminated.

The light scene may be modified by a user as a show in the bottom of FIG. 1. The modification may be performed by using the apparatus 204 for modifying a light scene composed from an abstract description. The apparatus 204 may be configured to adapt the abstract description stored in the memory 214 according to user-defined modifications. An adapted abstract description may be used by the means 202 for composing in order to compose a modified light scene.

According to this embodiment, the apparatus 204 comprises means 252 for selecting, means 254 for modifying, means 256 for recording and means 258 for adapting.

The means 252 for selecting are configured to allow a user to select an area 232, 234 of the light scene. For example, the area 234 may be selected by the user. The means 252 for selecting may comprise a pointing tool. The user may take the pointing tool to select the area 234 by pointing the pointing tool towards the area 234 to be selected. Information about the selected area 234 may be provided to the means 254 for modifying.

The means 254 for modifying allows the user to modify a light condition of the selected area 234. The means 254 for modifying may be configured to allow the user to input a modification command to modify the light condition of the selected area 234. Therefore, a user interface which allows the user to input the modification command may be provided by the means 254 for modifying. In order to modify the light condition of the selected area 234, the means 254 for modifying may be configured to interact with a control system of the lighting system. The control system may be part of the means 202 for composing which controls settings of the light sources 222, 224. Further, the means 254 for modifying may be configured to change the abstract description in order to modify the light condition of the selected area 234.

Alternatively or additionally the means 254 for modifying may compromise or provide a movable light-emitting device. The light-emitting device may be used by the user to modify the light condition of the selected area 234 simply by shifting the light emitting device, for example toward or away from the selected area 234. Alternatively the light emitting device may be provided by the user.

The means 254 for modifying may be configured to provide a parameter that defines the modification of the light condition of the selected area 234 to the means 256 for recording. In case the means 254 for modifying is not capable of providing the parameter, the means 256 for recording may be configured to measure the relevant parameter or parameters. The means 256 for recording may comprise a sensor or detector for measuring the parameter. The recorded parameter may be provided to the means 258 for adapting by the means 256 for recording.

The means 258 for adapting may be configured to adapt the abstract description by deducing at least one value or command of the abstract description stored in the memory 214. The adapted abstract description may replace the original abstract description stored in the memory 214 and be used by the means 202 for composing to compose a modified light scene which includes the modification of the light condition of the selected area 234. Further, the means 258 for adapting may comprise a display for displaying the deduced value to the user.

Instead of adapting the abstract description itself, the means 258 for adapting may be configured to determine a filter that may be used by the means 202 for composing while interpreting or translating the abstract description. Due to the filter the means 202 for composing composes not the original light scene but the modified light scene. The filter may be realized by a look up table comprising values or commands of the original abstract description and replacement values or commands to be used as a replacement by the means 202 for composing.

FIG. 3 depicts a method for modifying a light scene composed from an abstract description, according to an embodiment of the invention. The method allows a user to modify a light scene composed from an abstract description. The method may provide modification data, which may be used to compose a modified light scene. The method for modifying may be used by the systems shown in FIG. 1 or FIG. 2.

In a first step 352, an area of the light scene is selected. The selection may be performed by a user who desires to modify a light condition of the area. In a second step 354, the light condition of the area is modified. Again the modification may be performed by the user. In a third step 356, at least one parameter referring to a modification of the light condition of the area is recorded. In a fourth step 358 the abstract description is adapted based on the at least one parameter. The third and fourth steps may be performed automatically.

A goal of the inventive approach is to adjust a light effect which is described as the effect it should have on the environment. An effect of lamps is manipulated by changing the controls or by adding extra light from other sources. The change in the effect is then determined and stored in the abstract description language. The abstract description language script contains a specification of the desired effects.

Features of the described embodiments may be combined or used in parallel when suitable.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. Apparatus (204) for modifying a light scene composed from an abstract description, comprising:
means (252) for selecting an area of the light scene;
means (254) for modifying a light condition of the area;
means (256) for recording at least one parameter referring to a modification of the light condition of the area; and
means (258) for adapting the abstract description based on the at least one parameter.

2. Apparatus according to claim 1, wherein the abstract description comprises an abstract description language script.

3. Apparatus according to claim 1, wherein the means (252) for selecting comprises a pointing tool allowing a user to select the area.

4. Apparatus according to claim 1, wherein the means (254) for modifying comprises a user interface allowing a user to input a modification command and wherein the means for modifying is configured to modify the light condition of the area based on the modification command.

5. Apparatus according to claim 1, wherein the means (254) for modifying is configured to interact with a control system which controls the light scene and/or to change the abstract description in order to modify the light condition of the area.

6. (canceled)

7. Apparatus according to claim 1, wherein the means (254) for modifying comprises a movable light emitting device allowing a user to modify the light condition of the area.

8. Apparatus according to claim 1, wherein the means (256) for recording comprises at least one detector for measuring the at least one parameter.

9. Apparatus according to claim 1, wherein the means (258) for adapting is configured to adapt the abstract description by deducing at least one value of the abstract description.

10. Apparatus according to claim 1, wherein the means (258) for adapting are configured to display the at least one value to the user.

11. Apparatus according to claim 1, wherein the means (258) for adapting is configured to adapt the abstract description by determining a filter which defines an interpretation of the abstract description.

12. Apparatus according to claim 11, wherein the filter comprises a look-up-table for storing interpretation values which are assigned to values of the abstract description.

13. A lighting system comprising:
means (202) for composing a light scene from an abstract description; and
an apparatus (204) according to claim 1.

14. Method for modifying a light scene composed from an abstract description, comprising the steps of:
selecting (352) an area of the light scene;
modifying (354) a light condition of the area;
recording (356) at least one parameter referring to a modification of the light condition of the area; and
adapting (358) the abstract description based on the at least one parameter.

15. A computer program enabled to carry out the method according to claim 14 when executed by a computer.

16. A record carrier storing a computer program according to claim 15.

17. A computer programmed to perform a method according to claim 14 and comprising an interface for communication with a lighting system.
